(19) United States
(12) Patent Application Publication
(10) Pub. No.: US 2023/0280669 A1
(43) Pub. Date: Sep. 7, 2023

(54) RESIN PARTICLES AND TONER

(71) Applicants: Natsuko MATSUSHITA, Shizuoka (JP); Junichi WATANABE, Shizuoka (JP); Kazuoki FUWA, Shizuoka (JP); Yuka MIZOGUCHI, Shizuoka (JP)

(72) Inventors: Natsuko MATSUSHITA, Shizuoka (JP); Junichi WATANABE, Shizuoka (JP); Kazuoki FUWA, Shizuoka (JP); Yuka MIZOGUCHI, Shizuoka (JP)

(21) Appl. No.: 18/113,085

(22) Filed: Feb. 23, 2023

(30) Foreign Application Priority Data
Mar. 2, 2022 (JP) 2022-031602
Dec. 28, 2022 (JP) 2022-211546

(51) Int. Cl. G03G 9/087; C08G 63/183; C08G 18/73; C08G 18/42

(52) U.S. Cl. CPC G03G 9/08755; C08G 63/183; C08G 18/73; C08G 18/4213; G03G 9/08764

(57) ABSTRACT

Resin particles are provided. The resin particles include one or more binder resins, a release agent, and a colorant. The one or more binder resins include an amorphous resin. The amorphous resin contains an alcohol component as one of the constituents thereof. The alcohol component includes a plant-derived alcohol component. The resin particles contain a tetrahydrofuran (THF)-insoluble component by an amount of from 5% by mass through 40% by mass.

### CROSS-REFERENCE TO RELATED APPLICATION

The present application claims priority under 35 U.S.C. § 119 to Japanese Patent Application No. 2022-031602, filed Mar. 2, 2022, and Japanese Patent Application No. 2022-211546, filed Dec. 28, 2022. The contents of which are incorporated herein by reference in their entirety.

### BACKGROUND OF THE INVENTION

### 1. Field of the Invention

The disclosures herein generally relate to resin particles and a toner.

### 2. Description of the Related Art

In recent years, toners having a low environmental impact have been in demand. Hence, for example, energy savings in the production process and use of plant-derived resins as binder resins are being studied.

However, it is known that use of plant-derived resins reduces strength of toners and causes trouble such as filming.

Here, Japanese Unexamined Patent Application Publication No. 2015-94920 discloses an electrostatic latent image-developing toner containing a plurality of toner particles, each of which is a pulverized toner particle and contains a binder resin, wherein the binder resin contains: a first polyester resin containing plant-derived 1,2-propanediol as an alcohol component; and a second polyester resin having a molecular weight higher than the molecular weight of the first polyester resin.

Japanese Unexamined Patent Application Publication No. 2015-25851 discloses a method for producing a toner using a plant-derived material, the method including a step of forming an anionic core having a zeta potential of −5 mV or lower at pH of 4, and a step of forming a shell layer on the surface of the core in a solution in which a cationic shell layer material is dissolved in a solvent, wherein during formation of the shell layer, miscibility of the shell layer material in the solvent is in the range of from 250% by mass through 1,000% by mass.

However, Japanese Unexamined Patent Application Publication No. 2015-94920 employs a pulverizing method as the method for producing the disclosed toner, and yet falls short of saving energy in the production process. Moreover, according to the technique disclosed in Japanese Unexamined Patent Application Publication No. 2015-25851, reduction in strength of a toner due to use of a plant-derived material still remains as a problem to be solved.

### SUMMARY OF THE INVENTION

In one embodiment, resin particles include: one or more binder resins; a release agent; and a colorant. The one or more binder resins include an amorphous resin. The amorphous resin contains an alcohol component as one of the constituents thereof. The alcohol component includes a plant-derived alcohol component. The resin particles contain a tetrahydrofuran (THF)-insoluble component by an amount of from 5% by mass through 40% by mass.

### DESCRIPTION OF THE PREFERRED EMBODIMENTS

The resin particles of the present disclosure will be described below. The present disclosure is not limited to the embodiments illustrated below, and other embodiments, additions, modifications, and deletions that are within reach of persons ordinarily skilled in the art may be made. Any mode in which the functions and the effects of the present disclosure are exhibited is included within the scope of the present disclosure.

The resin particles of the present disclosure include: one or more binder resins; a release agent; and a colorant. The one or more binder resins include an amorphous resin. The amorphous resin contains an alcohol component as one of the constituents thereof. The alcohol component includes a plant-derived alcohol component. The resin particles contain a tetrahydrofuran (THF)-insoluble component by an amount of from 5% by mass through 40% by mass.

As described above, it is known that toners containing plant-derived materials, particularly, plant-derived resins, have a reduced strength, and cause trouble such as filming. Here, a toner containing the resin particles of the present disclosure and thus containing a tetrahydrofuran (THF)-insoluble component by an amount of from 5% by mass through 40% by mass has a reinforced strength while having a reduced environmental impact. Specifically, hitherto, in order to improve, for example, toughness, storage stability, and durability of polyester resins, bisphenol A-propylene oxide adduct (BPA-PO) and bisphenol A-ethylene oxide adduct (BPA-EO) have been used as alcohol components. Meanwhile, proactive use of biomass in order to reduce environmental impact is accompanied by reduction in the amount of the BPA-PO and BPA-EO used. This reduces toughness of polyester resins, and worsens storage stability and durability of polyester resins. The present inventors' studies have found it possible to solve this problem while reducing environmental impact, by setting the amount of the tetrahydrofuran (THF)-soluble component in the resin particles to from 5% by mass through 40% by mass.

In the present disclosure, the proportion of a plant-derived alcohol component in all alcohol components of the amorphous resin is preferably 5% by mass or greater and more preferably from 5% by mass through 30% by mass.

In the resin particles of the present disclosure, it is preferable that the alcohol component of the amorphous resin includes plant-derived 1,2-propanediol. Existing techniques often use plant-derived 1,2-propanediol as the alcohol component of an amorphous resin. However, when the alcohol component is simply replaced with plant-derived 1,2-propanediol, toughness of polyester resins is reduced. The present disclosure can solve this problem by setting the amount of the tetrahydrofuran (THF)-insoluble component in the resin particles to from 5% by mass through 40% by mass as specified above.

It is preferable that the resin particles of the present disclosure further contain a crystalline resin as a binder resin.

According to this mode, the resin particles have an improved low temperature fixability.

In the present disclosure, it is preferable that the proportion of the crystalline resin in all binder resins be from 3% by mass through 20% by mass and more preferably from 5% by mass through 15% by mass.

It is also preferable that the resin particles of the present disclosure include polyethylene terephthalate (PET) or polybutylene terephthalate (PBT) as binder resins.

When the resin particles of the present disclosure are used as a toner, use of such resins that have an aromatic ring skeleton can improve strength and durability of the toner.

In the present disclosure, it is preferable that the proportion of the PET or the PBT in all binder resins be from 3% by mass through 45% by mass and more preferably from 5% by mass through 40% by mass.

Hence, the present disclosure has an object to provide resin particles that have a low environmental impact, and have excellent strength, excellent high-temperature fixability and excellent low-temperature fixability even though containing a plant-derived material.

The present disclosure can provide resin particles that have a low environmental impact, and have excellent strength, excellent high-temperature fixability and excellent low-temperature fixability even though containing a plant-derived material.

The resin particles of the present disclosure have a low environmental impact and have excellent strength and excellent low-temperature fixability even though containing a plant-derived material. Hence, the resin particles of the present disclosure are suitably used as a toner. An embodiment in which the resin particles of the present disclosure are used as a toner will be described below.

Next, the method for producing the resin particles of the present disclosure will be described.

(Oil phase producing step)

In the method for producing the resin particles of the present disclosure, first, an oil phase in which, for example, resins, a colorant, a cross-linking component, and a release agent are dissolved or dispersed in an organic solvent is produced. To produce the oil phase, for example, the resins and the colorant may be gradually added and dissolved or dispersed in the organic solvent while stirring the organic solvent. For dispersing, a publicly-known measure can be used. For example, a disperser such as a bead mill or a disk mill can be used.

The materials used in the oil phase producing step will be described.

<Binder Resin>

Binder resins in the present disclosure include an amorphous resin.

As the amorphous resin, amorphous polyester resins advantageous for low-temperature fixing are preferable. Among amorphous polyester resins, liner polyester resins are preferably used, and unmodified polyester resins are preferably used.

The unmodified polyester resin represents a polyester resin that is obtained by using: a multivalent alcohol; and either a multivalent carboxylic acid such as a multivalent carboxylic acid, a multivalent carboxylic anhydride, and a multivalent carboxylate or a derivative of the multivalent carboxylic acid, and that is not modified with, for example, an isocyanate compound.

It is preferable to use a plant-derived alcohol monomer as the alcohol component of the amorphous resin.

As the plant-derived alcohol monomer, 1,2-propanediol is more preferable.

It is preferable to use terephthalic acid or succinic acid as the acid component. Likewise, a plant-derived component is preferable as the acid component.

It is preferable that the amorphous polyester resin be free of a urethane bond and a urea bond.

It is preferable that the amorphous polyester resin contains a dicarboxylic acid component as a constituent, and that the proportion of terephthalic acid in the dicarboxylic acid components be 50 mol % or greater. This is advantageous for heat-resistant storage stability.

Examples of the multivalent alcohol include diols.

In addition to 1,2-propanediol mentioned above, examples of the diols include: adducts of bisphenol A with alkylene (containing from 2 through 3 carbon atoms) oxides (average number of moles added: from 1 through 10), such as polyoxypropylene (2.2)-2,2-bis(4-hydroxyphenyl)propane and polyoxyethylene (2.2)-2,2-bis(4-hydroxyphenyl)propane; ethylene glycol; hydrogenated bisphenol A; and adducts of hydrogenated bisphenol A with alkylene (containing from 2 through 3 carbon atoms) oxides (average number of moles added: from 1 through 10).

One of these multivalent alcohols may be used alone or two or more of these multivalent alcohols may be used in combination.

Examples of the multivalent carboxylic acid include dicarboxylic acid.

Examples of the dicarboxylic acid include adipic acid, phthalic acid, isophthalic acid, terephthalic acid, fumaric acid, and maleic acid; and succinic acid replaced with an alkyl group containing from 1 through 20 carbon atoms or with an alkenyl group containing from 2 through 20 carbon atoms, such as dodecenyl succinic acid and octyl succinic acid.

Among these dicarboxylic acids, it is preferable to use a plant-derived saturated aliphatic succinic acid.

One of these multivalent carboxylic acids may be used alone or two or more of these multivalent carboxylic acids may be used in combination.

For adjustment of acid value and hydroxyl value, the amorphous polyester resin may contain either or both of a trivalent or greater carboxylic acid and a trivalent or greater alcohol at a terminal of its resin chain.

Examples of the trivalent or greater carboxylic acid include trimellitic acid and pyromellitic acid, or anhydrides of these acids.

Examples of the trivalent or greater alcohol include glycerin, pentaerythritol, and trimethylolpropane.

The molecular weight of the amorphous polyester resin is not particularly limited and may be appropriately selected in accordance with the intended purpose. The weight average molecular weight (Mw) of the amorphous polyester resin measured by gel permeation chromatography (GPC) is preferably from 3,000 through 10,000. The number average molecular weight (Mn) of the amorphous polyester resin is preferably from 1,000 through 4,000. Mw/Mn is preferably from 1.0 through 4.0.

When the molecular weight of the amorphous polyester resin is greater than or equal to the lower limit, it is possible to inhibit reduction in heat-resistant storage stability of the toner and in durability of the toner against stress due to, for example, being stirred in a developing device. When the molecular weight of the amorphous polyester resin is less than or equal to the upper limit, it is possible to inhibit increase in viscoelasticity of the toner during melting, and to inhibit reduction in low-temperature fixability of the toner.

The weight average molecular weight (Mw) of the amorphous polyester resin is more preferably from 4,000 through 7,000. The number average molecular weight (Mn) of the amorphous polyester resin is more preferably from 1,500 through 3,000. Mw/Mn is more preferably from 1.0 through 3.5.

The acid value of the amorphous polyester resin is not particularly limited, may be appropriately selected in accordance with the intended purpose, yet is preferably from 1 mgKOH/g through 50 mgKOH/g, and more preferably from 5 mgKOH/g through 30 mgKOH/g. When the acid value of the amorphous polyester resin is 1 mgKOH/g or greater, the toner tends to be charged negatively, and tends to have both a good affinity with paper and an improved low-temperature fixability. When the acid value of the amorphous polyester resin is 50 mgKOH/g or less, it is possible to inhibit reduction in charging stability of the toner, particularly, charging stability of the toner against environmental changes.

The hydroxyl value of the amorphous polyester resin is not particularly limited, may be appropriately selected in accordance with the intended purpose, yet is preferably from 5 mgKOH/g or greater.

The glass transition temperature (Tg) of the amorphous polyester resin is preferably 40° C. or higher and 80° C. or lower, and more preferably 50° C. or higher and 70° C. or lower. When the glass transition temperature (Tg) of the amorphous polyester resin is 40° C. or higher, the toner has a sufficient heat-resistant storage stability, a sufficient durability against stress due to, for example, being stirred in a developing device, and a good anti-filming property. When the glass transition temperature (Tg) of the amorphous polyester resin is 80° C. or lower, the toner sufficiently deforms when heated or pressurized during fixing, and has a good low-temperature fixability.

It is possible to confirm the molecular structure of the amorphous polyester resin by, for example, solution NMR or solid NMR, X-ray diffractometry, GC/MS, LC/MS, and IR measurement. As a simple method, there is a method of detecting a resin that does not exhibit olefins' out-of-plane bending vibration (δCH) absorption at 965±10 cm⁻¹ and 990±10 cm⁻¹ in infrared spectroscopy, as the amorphous polyester resin.

The content of the amorphous polyester resin is not particularly limited, may be appropriately selected in accordance with the intended purpose, yet is preferably from 50 parts by mass through 90 parts by mass and more preferably from 60 parts by mass through 80 parts by mass relative to 100 parts by mass of the toner. When the content of the amorphous polyester resin is 50 parts by mass or greater, it is possible to inhibit worsening of dispersibility of a pigment and a release agent in the toner, and to inhibit occurrence of fogged images or images printed out of order. When the content of the amorphous polyester resin is 90 parts by mass or less, it is possible to inhibit reduction in low-temperature fixability. When the content of the amorphous polyester resin is in the more preferable range, there is an advantage that excellent high image quality and excellent low-temperature fixability can both be obtained.

(Crystalline Resin)

In order to improve low-temperature fixability, it is preferable to add a crystalline resin to the toner of the present disclosure.

The crystalline resin is not particularly limited and may be appropriately selected in accordance with the intended purpose so long as the crystalline resin has crystallinity. Examples of the crystalline resin include polyester resins, polyurethane resins, polyurea resins, polyamide resins, polyether resins, vinyl resins, and modified crystalline resins. One of these crystalline resins may be used alone or two or more of these crystalline resins may be used in combination.

Crystalline polyester will be described below.

(Crystalline Polyester Resin)

A crystalline polyester resin is obtained from: a multivalent alcohol; and either a multivalent carboxylic acid such as a multivalent carboxylic acid, a multivalent carboxylic anhydride, and a multivalent carboxylate or a derivative of the multivalent carboxylic acid.

In the present disclosure, a crystalline polyester resin represents one that is obtained by using: a multivalent alcohol; and either a multivalent carboxylic acid such as a multivalent carboxylic acid, a multivalent carboxylic anhydride, and a multivalent carboxylate or a derivative of the multivalent carboxylic acid as mentioned above. Modified polyester resins, such as prepolymers and resins obtained through either or both of cross-linking reaction and elongation reaction of the prepolymers do not belong to the crystalline polyester resin.

<<Multivalent Alcohol>>

The multivalent alcohol is not particularly limited and may be appropriately selected in accordance with the intended purpose. Examples of the multivalent alcohol include diols and trivalent or greater alcohols.

Examples of the diols include saturated aliphatic diols. Examples of the saturated aliphatic diols include straight-chain saturated aliphatic diols and branched saturated aliphatic diols. Among these saturated aliphatic diols, straight-chain saturated aliphatic diols are preferable, and straight-chain saturated aliphatic diols containing from 2 through 12 carbon atoms are more preferable. A branched saturated aliphatic diol may reduce crystallinity and melting point of the crystalline polyester resin. When the number of carbon atoms in the saturated aliphatic diols is greater than 12, materials that can be actually used as such diols are not easily available.

Examples of the saturated aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol. Among these saturated aliphatic diols, ethylene glycol, 1,4-butanediol, 1,6-hexanediol, 1,8-octanediol, 1,9-nonanediol, 1,10-decanediol, and 1,12-dodecanediol are preferable because they can impart a high crystallinity and an excellent sharp melting property to the crystalline polyester resin.

Examples of the trivalent or greater alcohols include glycerin, trimethylolethane, trimethylolpropane, and pentaerythritol. One of these multivalent alcohols may be used alone or two or more of these multivalent alcohols may be used in combination.

<<Multivalent Carboxylic Acid>>

The multivalent carboxylic acid is not particularly limited and may be appropriately selected in accordance with the intended purpose. Examples of the multivalent carboxylic acid include divalent carboxylic acid and trivalent or greater carboxylic acid.

Examples of the divalent carboxylic acid include: saturated aliphatic dicarboxylic acid such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecandicarboxylic acid, 1,14-tetradecanedicarboxylic acid, and 1,18-octadecanedicarboxylic acid; and aromatic dicarboxylic acid such as phthalic acid, isophthalic acid, terephthalic acid, naphthalene-2,6-dicarboxylic acid, malonic acid, and mesaconic acid. Examples of the divalent carboxylic acid also include anhydrides and lower (containing from 1 through 3 carbon atoms) alkyl esters of these divalent carboxylic acids.

Among divalent carboxylic acids, plant-derived saturated aliphatic dicarboxylic acids containing 12 or less carbon atoms are preferable in terms of carbon neutrality.

Derivation from plants can increase carbon neutrality. Saturated aliphatic dicarboxylic acids have an effect of increasing re-crystallinity of the crystalline polyester resin, and can increase aspect ratio and low-temperature fixability of the crystalline polyester resin.

Examples of the trivalent or greater carboxylic acid include 1,2,4-benzenetricarboxylic acid, 1,2,5-benzenetricarboxylic acid, 1,2,4-naphthalene tricarboxylic acid, and anhydrides and lower (containing from 1 through 3 carbon atoms) alkyl esters of these trivalent or greater carboxylic acids.

One of these multivalent carboxylic acids may be used alone or two or more of these multivalent carboxylic acids may be used in combination.

It is preferable that the crystalline polyester resin be formed of straight-chain saturated aliphatic dicarboxylic acid containing from 4 through 12 carbon atoms and straight-chain saturated aliphatic diol containing from 2 through 12 carbon atoms. They can impart a high crystallinity and an excellent sharp melting property to the crystalline polyester resin. Therefore, the crystalline polyester resin can exhibit excellent low-temperature fixability.

Examples of the method for controlling crystallinity and softening point of the crystalline polyester resin include a method of designing or using, for example, nonlinear polyester that is obtained through condensation polymerization of a trivalent or greater multivalent alcohol such as glycerin added as an alcohol component and a trivalent or greater multivalent carboxylic acid such as trimellitic anhydride added as an acid component during synthesis of the crystalline polyester.

It is possible to confirm the molecular structure of the crystalline polyester resin of the present disclosure by, for example, solution NMR or solid NMR, X-ray diffractometry, GC/MS, LC/MS, and IR measurement. Simply, the crystalline polyester resin exhibits olefins' out-of-plane bending vibration (δCH) absorption at 965±10 cm⁻¹ or 990±10 cm⁻¹ in infrared spectroscopy.

As a result of earnest studies into the molecular weight of the crystalline polyester resin from the perspectives that a low-molecular-weight fraction of the crystalline polyester resin having a sharp molecular weight distribution has excellent low-temperature fixability, and that presence of the low-molecular-weight fraction in a large quantity worsens heat-resistant storage stability of the crystalline polyester resin, it is preferable that an o-dichlorobenzene-soluble component of the crystalline polyester resin has a peak in the range of form 3.5 through 4.0, a peak half-value width of 1.5 or less, a weight average molecular weight (Mw) of from 3,000 through 30,000, a number average molecular weight (Mn) of from 1,000 through 10,000, and Mw/Mn of from 1 through 10 in the plot of a GPC molecular weight distribution representing log(M) on the horizontal axis and weight percentage on the vertical axis.

Moreover, it is preferable that the o-dichlorobenzene-soluble component of the crystalline polyester resin has a weight average molecular weight (Mw) of from 5,000 through 15,000, a number average molecular weight (Mn) of from 2,000 through 10,000, and Mw/Mn of from 1 through 5.

The acid value of the crystalline polyester resin is preferably 5 mgKOH/g or greater in order to achieve the intended low-temperature fixability in terms of affinity between paper and the resin, and is more preferably 7 mgKOH/g or greater in order to produce resin particles by a phase-inversion emulsifying method, whereas the acid value of the crystalline polyester resin is preferably 45 mgKOH/g or less in order to improve hot-offset resistance. The hydroxyl value of the crystalline polymer is preferably from 0 mgKOH/g through 50 mgKOH/g and more preferably from 5 mgKOH/g through 50 mgKOH/g in order to achieve a predetermined low-temperature fixability and a good chargeability.

<PET and PBT>

As mentioned above, in the present disclosure, it is preferable that the binder resins include polyethylene terephthalate (PET) or polybutylene terephthalate (PBT).

PET and PBT may be recycled ones that are processed into the form of flakes. PET and PBT have a weight average molecular weight (Mw) of approximately from 30,000 through 100,000. However, for example, the molecular weight distribution, composition, production method, and form of use of PET and PBT are not particularly limited. Moreover, PET and PBT are not limited to recycled ones, and out-of-specs plastic fiber wastes or pellets may also be used.

(Colorant)

Publicly-known dyes and pigments can be used as the colorant used in the present disclosure. Examples of the dyes and pigments that can be used include carbon black, nigrosine dyes, iron black, naphthol yellow S, Hansa yellow (10G, 5G, G), cadmium yellow, yellow iron oxide, ocher, chrome yellow, titanium yellow, polyazo-yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrazine yellow BGL, isoindolinone yellow, red iron oxide, red lead, vermillion lead, cadmium red, cadmium mercury red, antimony red, permanent red 4R, para red, faicer red, parachloroorthonitroaniline red, lithol fast scarlet G, brilliant fast scarlet, brilliant carmine BS, permanent red (F2R, F4R, FRL, FRLL, F4RH), fast scarlet VD, Vulcan fast rubin B, brilliant scarlet G, lithol rubin GX, permanent red F5R, brilliant carmine 6B, pigment scarlet 3B, Bordeaux 5B, toluidine maroon, permanent Bordeaux F2K, Helio Bordeaux BL, Bordeaux 10B, bon maroon light, bon maroon medium, eosin lake, rhodamine lake B, rhodamine lake Y, alizarin lake, thioindigo red B, thioindigo maroon, oil red, quinacridone red, pyrazolone red, polyazo red, chrome vermillion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS, BC), indigo, ultramarine blue, Prussian blue, anthraquinone blue, fast violet B, methyl violet lake, cobalt purple, manganese purple, dioxane violet, anthraquinone violet, chrome green, zinc green, chrome oxide, viridian, emerald green, pigment green B, naphthol green B, green gold, acid green lake, Malachite green lake, phthalocyanine green, anthraquinone green, titanium oxide, zinc oxide, and lithopone, and mixtures of these dyes and pigments.

The addition amount of the colorant in the toner containing the resin particles of the present disclosure is preferably from 1% by mass through 15% by mass and more preferably 3% by mass through 10% by mass.

(Release Agent)

The release agent is not particularly limited and may be appropriately selected in accordance with the intended purpose. A low-melting-point release agent having a melting point of from 50° C. through 120° C. is preferable. By being dispersed with the resins, a low-melting-point release agent effectively functions as a release agent at the interface between a fixing roller and the toner and realizes a good hot-offset resistance even in an oil-free system (i.e., without application of a release agent such as an oil to the fixing roller).

Preferable examples of the release agent include waxes. Examples of the waxes include natural waxes such as: vegetable waxes (e.g. carnauba wax, cotton wax, Japan tallow, and rice wax); animal waxes (e.g., as beeswax and lanolin); mineral waxes (e.g., as ozocerite and ceresin); and petroleum waxes (e.g., paraffin, microcrystalline, and petrolatum). Examples of the waxes other than the natural waxes include synthetic hydrocarbon waxes such as Fischer Tropsch wax and polyethylene wax; and synthetic waxes such as ester, ketone, and ether. Moreover, fatty acid amides such as 12-hydroxystearic acid amide, stearic acid amide, anhydrous phthalic acid imide, and chlorinated hydrocarbon; homopolymers of polyacrylates, which are low-molecular-weight crystalline polymeric resins, such as poly-n-stearyl methacrylate and poly-n-lauryl methacrylate, or copolymers of the polyacrylates such as n-stearyl acrylate-ethyl methacrylate copolymer; and crystalline polymeric compounds having a long alkyl group in a side chain may also be used. One of these release agents may be used alone or two or more of these release agents may be used in combination.

Vegetable waxes are preferable in terms of carbon neutrality.

The melting point of the wax is not particularly limited, may be appropriately selected in accordance with the intended purpose, yet is preferably from 50° C. through 120° C. and more preferably from 60° C. through 90° C. When the melting point of the wax is 50° C. or higher, it is possible to inhibit the wax from adversely affecting heat-resistant storage stability. When the melting point of the wax is 120° C. or lower, it is possible to effectively inhibit occurrence of cold offset during fixing at a low temperature. The melt viscosity of the wax, measured at a temperature higher than the melting point of the was by 20° C., is preferably from 5 cps through 1,000 cps, and more preferably from 10 cps through 100 cps. When the melt viscosity of the wax is 5 cps or higher, it is possible to inhibit reduction in releasability. When the melt viscosity of the wax is 1,000 cps or lower, hot-offset resistance and low-temperature fixability can be sufficiently exhibited. The content of the wax in the toner is not particularly limited, may be appropriately selected in accordance with the intended purpose, yet is preferably from 0% by mass through 40% by mass and more preferably from 3% by mass through 30% by mass. When the content of the wax in the toner is 40% by mass or less, it is possible to inhibit worsening of flowability of the toner.

(Organic Solvent)

It is preferable that the organic solvent used in the present disclosure has a boiling point of lower than 100° C. and volatility, because it is easy to remove the organic solvent afterwards.

As such an organic solvent, for example, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, and isopropyl alcohol may be used alone or in combination. When resins to be dissolved or dispersed in the organic solvent have a polyester skeleton, it is preferable to use an ester-based solvent such as methyl acetate, ethyl acetate, and butyl acetate or a ketone-based solvent such as methyl ethyl ketone and methyl isobutyl ketone because resins have a higher solubility in these organic solvents. Among these organic solvents, methyl acetate, ethyl acetate, and methyl ethyl ketone that have a high removability are particularly preferable.

(Prepolymer)

A nonlinear reactive precursor is not particularly limited and may be appropriately selected in accordance with the intended purpose so long as the nonlinear reactive precursor is polyester that contains a group reactive with a metal ion (hereinafter, such polyester may be referred to as prepolymer).

Examples of the group of the prepolymer reactive with a metal ion include carboxylic acid.

Prepolymers are nonlinear. “Nonlinear” means having a branched structure that is imparted by either or both of a trivalent or greater alcohol and a trivalent or greater carboxylic acid.

The trivalent or greater alcohol is not particularly limited and may be appropriately selected in accordance with the intended purpose. Examples of the trivalent or greater alcohol include trivalent or greater aliphatic alcohols, trivalent or greater polyphenols, and adducts of trivalent or greater polyphenols with alkylene oxide.

Examples of the trivalent or greater aliphatic alcohols include glycerin, trimethylolethane, trimethylolpropane, pentaerythritol, and sorbitol.

Examples of the trivalent or greater polyphenols include trisphenol PA, phenol novolac, and cresol novolac.

Examples of the adducts of trivalent or greater polyphenols with alkylene oxide include adducts of trivalent or greater polyphenols with alkylene oxide such as ethylene oxide, propylene oxide, and butylene oxide.

The trivalent or greater carboxylic acid is not particularly limited and may be appropriately selected in accordance with the intended purpose. Examples of the trivalent or greater carboxylic acid include trivalent or greater aromatic carboxylic acids. Anhydrides, lower (containing from 1 through 3 carbon atoms) alkyl esterified products, and halides of these trivalent or greater aromatic carboxylic acids may also be used.

As the trivalent or greater aromatic carboxylic acid, trivalent or greater aromatic carboxylic acid containing from 9 through 20 carbon atoms is preferable. Examples of the trivalent or greater aromatic carboxylic acid containing from 9 through 20 carbon atoms include trimellitic acid and pyromellitic acid.

A nonlinear polymer is obtained through reaction between the nonlinear reactive precursor and the metal ion.

The metal cross-linked product of the nonlinear polymer is formed of a metal ion of a metal salt and has an excellent charging property because it is free of urethane and urea groups.

The resin particles of the present disclosure contain a tetrahydrofuran (THF)-insoluble component by an amount of from 5% by mass through 40% by mass.

The method for making the resin particles contain the THF-insoluble component is not particularly limited. When synthesizing the resin particles as a polymerization toner, it is necessary to dissolve or minutely disperse the resins in advance of polymerization. Therefore, it is difficult to add the THF-insoluble component as a raw material.

Examples of the method for making the resin particles contain the THF-insoluble component include a method of adding the prepolymer specified above as the THF-insoluble component by an amount from which the THF-insoluble component of a desired amount can be obtained. By setting the amount of the THF-insoluble component in the resin particles to from 5% by mass through 40% by mass as described above, it is possible to provide resin particles having excellent strength and excellent high-temperature fixability even when a plant-derived material is used.

In the present disclosure, the method for measuring the THF-insoluble component is not particularly limited. Examples of the method include a dissolution filtration method, and a measuring method according to the common Soxhlet extraction method. In the present disclosure, the THF-insoluble component is measured by the dissolution filtration method described below.

First, the resin particles (e.g., toner) are weighed out to 1 g, added to THF (100 mL), and stirred in an environment at 25° C. for 6 hours using a stirrer, to obtain a solution in which soluble components of the toner are dissolved.

Next, the solution is filtrated through a membrane filter having a mesh size of 0.2 μm. The filtrated product is again added to THF (50 mL) and stirred for 10 minutes using a stirrer. This operation is repeated two or three times, and the obtained filtrated product is dried in an environment at 120° C. at 10 kPa or lower, to obtain a THF-insoluble component. When employing the Soxhlet extraction method, it is preferable to reflux the toner and THF at a ratio of 1 part by mass to 100 parts by mass for 6 hours or longer, to fractionate the toner into a THF-insoluble fraction and a THF-soluble fraction.

As specified above, in the present disclosure, the amount of the THF-insoluble component is from 5% by mass through 40% by mass and more preferably from 20% by mass through 35% by mass. When the amount of the THF-insoluble component is 5% by mass or greater, high-temperature fixability does not worsen, and it is possible to compensate for reduction in strength due to a plant-derived resin. When the amount of the THF-insoluble component is 40% by mass or less, high-temperature fixability does not worsen, and this is advantageous.

The content of the THF-insoluble component in the toner of the present disclosure is calculated according to the formula below using an electronic scale.

(Amount (g) of THF-insoluble component/amount (g) of toner before extraction)×100

For example, a charge controlling agent may be added to the oil phase.

(Charge Controlling Agent)

As the charge controlling agent, all publicly-known charge controlling agents can be used. Examples of the charge controlling agent include nigrosine-based dyes, triphenylmethane-based dyes, chromium-containing metal complex dyes, molybdic acid chelate pigments, rhodamine-based dyes, alkoxy-based amines, quaternary ammonium salts (including fluorine-modified quaternary ammonium salts), alkyl amides, phosphorus or phosphorus compounds, tungsten or tungsten compounds, fluorine-based active agents, metal salts of salicylic acid, and metal salts of salicylic acid derivatives.

Specific examples of the charge controlling agent include a nigrosine-based dye BONTRON 03, a quaternary ammonium salt BONTRON P-51, a metal-containing azo-dye BONTRON S-34, an oxynaphthoic acid-based metal complex E-82, a salicylic acid-based metal complex E-84, and a phenol-based condensate E-89 (all available from Orient Chemical Industries Co., Ltd.), quaternary ammonium salt molybdenum complexes TP-302 and TP-415 (both available from Hodogaya Chemical Co., Ltd.), a quaternary ammonium salt COPY CHARGE PSY VP2038, a triphenylmethane derivative COPY BLUE PR, a quaternary ammonium salt COPY CHARGE NEG VP2036, and COPY CHARGE NX VP434 (all available from Hoechst AG), LRA-901 and a boron complex LR-147 (both available from Japan Carlit Co., Ltd.), copper phthalocyanine, perylene, quinacridone, azo-based pigments, and other polymeric compounds containing functional groups such as a sulfonic acid group, a carboxyl group, and quaternary ammonium salt.

The charge controlling agent need only be used in an amount in which the charge controlling agent can express its function and does not inhibit, for example, fixability. The amount of the charge controlling agent in the toner is from 0.5% by mass through 5% by mass and preferably from 0.8% by mass through 3% by mass.

(Phase-Inversion Emulsifying Step)

Next, the oil phase obtained in the oil phase producing step is granulated to particles.

In the present disclosure, a particle dispersion liquid is obtained by phase-inversion emulsification of neutralizing the oil phase with an alkali such as sodium hydroxide or ammonia water, and adding ion-exchanged water to the resulting product, to invert the phase from a water-in-oil dispersion liquid to an oil-in-water dispersion liquid.

(Solvent Removal)

In order to remove the organic solvent from the obtained particle dispersion liquid, a method of gradually elevating the temperature of the whole system while stirring the system, to evaporate and remove the organic solvent completely from the liquid droplets can be employed. Alternatively, it is also possible to remove the organic solvent completely from the liquid droplets by spraying the obtained particle dispersion liquid into a dry atmosphere while stirring the particle dispersion liquid. Yet alternatively, it is also possible to evaporate and remove the organic solvent by decompressing the particle dispersion liquid while stirring the particle dispersion liquid. The last two methods may be used in combination with the first method.

As the dry atmosphere into which the particle dispersion liquid is sprayed, for example, gases obtained by heating air, nitrogen, carbon dioxide, and combustion gases, and particularly, various kinds of airflows heated to a temperature higher than or equal to the boiling point of the solvent having the highest boiling point among the solvents used are commonly used. It is possible to obtain an intended quality sufficiently through a short-time process using a spray dryer, a belt dryer, and a rotary kiln.

A coloring particle dispersion liquid from which the solvent is removed can be obtained by the method described above.

(Flocculating Step)

Next, the obtained coloring particle dispersion liquid is flocculated while being stirred, until the particles become a desirably selected particle diameter. For flocculation, existing methods such as addition of a flocculant and pH adjustment may be used. When adding a flocculant, the flocculant may be added as is, but addition of an aqueous solution of the flocculant is preferred because it is possible to avoid local increase in the concentration. It is preferable to add a salt serving as the flocculant gradually while observing the particle diameter of the coloring particles.

The temperature of the dispersion liquid during flocculation is preferably around the Tg of the resins used. If the liquid temperature is extremely low, flocculation does not go smoothly and efficiency is poor. If the liquid temperature is extremely high, the flocculation speed is high and the particle diameter distribution worsens as represented by occurrence of coarse particles.

When the particles in the dispersion liquid reach the intended particle diameter, flocculation is terminated. As the method for terminating flocculation, for example, a method of adding a salt having a low ion valence or a chelate agent, a method of adjusting pH, a method of lowering the temperature of the dispersion liquid, and a method of adding an aqueous medium by a large quantity to dilute the concentration can be used.

A dispersion liquid of flocculated coloring particles can be obtained by the method described above.

In the flocculating step, a wax may be added as a release agent or a crystalline resin may be added for low-temperature fixability. In this case, a dispersion liquid obtained by dispersing a wax in an aqueous medium or a similar dispersion liquid of a crystalline resin is prepared, and the coloring particle dispersion liquid is flocculated after being mixed with the prepared dispersion liquid. In this way, it is possible to obtain flocculated particles among which the wax or the crystalline resin is dispersed uniformly.

(Flocculant)

As the flocculant, a publicly-known flocculant can be used. For example, metal salts of monovalent metals such as sodium and potassium, metal salts of divalent metals such as calcium and magnesium, and metal salts of trivalent metals such as iron and aluminum can be used.

(Fusing Step)

Next, the obtained flocculated particles are fused through a thermal treatment, to reduce coarseness of the particles and make the shape of the particles spherical. For fusing, the flocculated particle dispersion liquid may be heated while being stirred. The liquid temperature is preferably around a temperature higher than Tg of the resins used.

(Washing and Drying Step)

The toner particle dispersion liquid obtained by the method described above contain not only the toner particles, but also sub materials such as the salt serving as the flocculant. Hence, the dispersion liquid is washed in order to extract only the toner particles from the dispersion liquid. Examples of the method for washing the toner particles include a centrifugation method, a reduced-pressure filtration method, and a filter press method. In the present disclosure, the washing method is not particularly limited. By any of these methods, a cake of the toner particles is obtained. When the toner particles cannot be washed sufficiently by one operation, the obtained cake may be dispersed again in an aqueous solvent and slurried, and the step of extracting the toner particles by any of the methods mentioned above may be repeated. Alternatively, when washing the toner particles by the reduced-pressure filtration method or the filter press method, a method of making an aqueous solvent permeate the cake to wash away the sub materials embraced by the coloring resin particles may be employed. As the aqueous solvent used for washing, water, or a mixed solvent in which an alcohol such as methanol and ethanol is mixed with water is used. It is preferable to use water when costs and environmental impact due to water disposal treatment are taken into consideration.

The washed toner particles are impregnated with a large quantity of the aqueous medium. Hence, by drying the toner particles to remove the aqueous medium, it is possible to obtain only the toner particles. As the drying method, dryers such as a spray dryer, a vacuum-freeze dryer, a reduced-pressure dryer, a stationary bed dryer, a moving bed dryer, a fluidized bed dryer, a rotary dryer, and a stirring dryer can be used. It is preferable to dry the toner particles until the water content ultimately becomes less than 1%. The coloring resin particles have become a weakly aggregated state through being dried. If this is inconvenient for use, it is optional to loosen the aggregated particles and resolve the weakly aggregated state using such a device as a jet mill, a Henschel mixer, a super mixer, a coffee mill, an OSTER BLENDER, and a food processor.

(Annealing Step)

When a crystalline resin has been added, an annealing treatment may be performed after drying. This causes phase separation between the non-crystalline resin and the crystalline resin and improves fixability. Specifically, the toner particles may be annealed by being kept at a temperature around Tg for 10 hours or longer.

(External Adding Step)

It is optional to add and mix, for example, inorganic particles, polymeric particles, and a cleaning aid to the toner particles obtained in the present disclosure in order to impart, for example, flowability, chargeability, and cleanability to the toner particles.

Specific examples of the mixing method include a method of applying an impact to the mixture using a blade rotating at a high speed, and a method of feeding the mixture to a high-speed airflow to accelerate the mixture and make the particles collide with each other or make combined particles collide against a suitable impact board. Examples of the device include an angmill (available from Hosokawa Micron Corporation), an I-TYPE MILL (available from Nippon Pneumatic Mfg. Co., Ltd.) remodeled to have a reduced grinding air pressure, a HYBRIDIZATION SYSTEM (available from Nara Machinery Co., Ltd.), a KRYPTRON SYSTEM (available from Kawasaki Heavy Industries, Ltd.), and an automatic mortar.

(External Additive)

The primary particle diameter of the inorganic particles is preferably from 5 nm through 2 μm, and particularly preferably from 5 nm through 500 nm. The BET specific surface area of the inorganic particles is from 20 m²/g through 500 m²/g. The percentage at which the inorganic particles are used in the toner is preferably from 0.01% by mass through 5% by mass. Specific examples of the inorganic particles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, colcothar, antimony trioxide, magnesium oxide, zirconium oxide, barium sulfate, barium carbonate, calcium carbonate, silicon carbide, and silicon nitride.

Examples of the polymeric particles include polymer particles of polycondensation-based thermosetting resins such as polystyrene, methacrylic acid ester, acrylic acid ester copolymer, silicone, benzoguanamine, and nylon obtained by soap-free emulsion polymerization, suspension polymerization, and dispersion polymerization.

Surface treatment may be applied to these kinds of fluidizers. This can increase hydrophobicity of the fluidizers and minimize worsening of flowability and chargeability even under high-humidity conditions. Preferable examples of surface-treating agents include silane coupling agents, silylation agents, silane coupling agents containing an alkyl fluoride group, organic titanate-based coupling agents, aluminum-based coupling agents, silicone oils, and modified silicone oils.

Examples of cleanability improving agents for removing a developer failing to be transferred and remaining on a photoconductor or a primary transfer medium include metal salts of fatty acids such as stearic acid (e.g., zinc stearate and calcium stearate), and polymer particles produced by soap-free emulsion polymerization, such as polymethyl methacrylate particles and polystyrene particles. Preferable polymer particles are those that have a relatively narrow granularity distribution and a volume mean particle diameter of from 0.01 μm through 1 μm.

(Measuring Method)

<Toner Particle Diameter>

The toner particle diameter can be measured with a COULTER MULTISIZER III (available from Beckman Coulter, Inc.). For example, the toner particle diameter is measured as follows.

First, a surfactant (sodium dodecylbenzene sulfonate, available from Tokyo Chemical Industry Co., Ltd.) (2 mL) is added as a dispersant to an electrolytic solution (100 mL). The electrolytic solution is an ISOTON-II (available from Beckman Coulter, Inc.), which is a NaCl aqueous solution having a concentration of approximately 1%, prepared using primary sodium chloride. To the mixture liquid of the electrolytic solution and the surfactant, the measurement sample is further added by 10 mg, which is expressed as a solid content, to obtain an electrolytic solution in which the sample is suspended. The electrolytic solution in which the sample is suspended is subjected to dispersion treatment for approximately from 1 minute through 3 minutes using an ultrasonic disperser. Then, the volume and number of the toner particles are measured with the COULTER MULTISIZER III using a 100 μm aperture as the aperture, and the volume distribution and number distribution of the toner particles are calculated. The volume mean particle diameter (Dv) of the toner is calculated from the obtained distributions.

<Mean Particle Diameter and Average Circularity>

In the present embodiment, for example, a flow-type particle image analyzer FPIA-3000 (available from Sysmex Corporation) is used for measuring the mean particle diameter and the average circularity.

As a specific measurement method, a surfactant serving as a dispersant, preferably an alkyl benzene sulfonate (from 0.1 ml through 0.5 ml), and then the measurement sample (approximately from 0.1 g through 0.5 g) are added to water (from 100 ml through 150 ml) that is contained in a container and from which impurity solids have been removed previously. The suspension liquid in which the sample is dispersed is subjected to dispersion treatment for approximately from 1 minute through 3 minutes using an ultrasonic disperser in a manner that the concentration of the dispersion liquid becomes from 3,000 particles/μl through 10,000 particles/μl. Then, the mean particle diameter, the average circularity, and the standard deviation (SD) of the circularity are measured using the instrument specified above.

The particle diameter assumed here is the equivalent circle diameter. The mean particle diameter is calculated based on the equivalent circle diameter (number base). The analyzing conditions of the flow-type particle image analyzer are as follows.

Particle diameter limits:

0.5 μm≤equivalent circle diameter (number base)≤200.0 μm

Particle shape limits:

0.93<circularity≤1.00

In the present embodiment, the average circularity is defined as follows.

(Average circularity)=(Perimeter of a circle having the same area as a projected area)/(Perimeter of a projected image)

<Molecular Weight Measurement>

The molecular weight of each constituent of the toner can be measured by, for example, the method described below.
Gel permeation chromatography (GPC) measuring instrument: GPC-8220GPC (available from Tosoh Corporation)
Columns: TSK GEL SUPER HZM-H (15 cm, three serial columns (available from Tosoh Corporation))
Temperature: 40° C.
Solvent: THF
Flow rate: 0.35 mL/min
Sample: a 0.15% by mass sample is injected by 100 μL
Sample pre-treatment: a toner (0.15% by mass) is dissolved in tetrahydrofuran (THF) (containing a stabilizing agent, available from Wako Pure Chemical Corporation), and then filtrated through a 0.2 μm filter. The obtained filtrate is used as the sample. The THF sample solution is injected by 100 μL and measured.

For measuring the molecular weight of the sample, the molecular weight distribution of the sample is calculated based on the relationship between counted values and logarithmic values on a calibration curve generated using several kinds of monodisperse polystyrene standard samples. As the standard polystyrene samples for generating the calibration curve, SHOWDEX STANDARD Std. Nos. S-7300, S-210, S-390, S-875, S-1980, S-10.9, S-629, S-3.0, and S-0.580 available from Showa Denko K.K. are used. As the detector, a refractive index (RI) detector is used.

<THF-Insoluble Component>

First, a toner is weighed out to 1 g, added to THF (100 mL), and stirred in an environment at 25° C. for 6 hours using a stirrer, to obtain a solution in which soluble components of the toner are dissolved. Next, the solution is filtrated through a membrane filter having a mesh size of 0.2 μm. The filtrated product is again added to THF (50 mL), and stirred for 10 minutes using a stirrer. This operation is repeated two or three times, and the obtained filtrated product is dried in an environment at 120° C. at 10 kPa or lower, to obtain a THF-insoluble component (gel component).

<Method for Analyzing Toner Constituents>

Any kinds of methods may be used to analyze the plant-derived alcohol component, and PET and PBT. For example, it is possible to qualitatively analyze the plant-derived alcohol component, and PET and PBT by separating them from the toner by, for example, gel permeation chromatography (GPC), and analyzing each separated component by a publicly-known analyzing method.

Moreover, it is possible to estimate the main constituents through soft decomposition of the ester bonding site of the resin structure in response to methylation by gas chromatography-mass spectrometry at 300° C. using a reaction reagent (10% tetramethyl ammonium hydroxide (TMAH)/methanol solution.

### EXAMPLES

The present disclosure will be described below by way of Examples. The present disclosure should not be construed as being limited to Examples below. “Part” represents “part by mass”, unless otherwise specified.

### Production Example A-1: Synthesis of Prepolymer A-1

3-Methyl-1,5-pentanediol, isophthalic acid, and adipic acid were added together with titanium tetraisopropoxide (1,000 ppm relative to the resin components) into a reaction container equipped with a heater, a condenser tube, a stirrer, and a nitrogen introducing tube. Here, the mole ratio (OH:COOH) between hydroxyl group and carboxyl group was adjusted to 1.1, the diol component constitution was adjusted to 110 mol % of 3-methyl-1,5-pentanediol, and the dicarboxylic acid constitution was adjusted to 40 mol % of isophthalic acid and 60 mol % of adipic acid. Subsequently, the materials were subjected to temperature elevation to 200° C. in approximately 4 hours, then subjected to temperature elevation to 230° C. in 2 hours, and reacted until no water flowed out. Subsequently, the materials were further reacted at a reduced pressure of from 10 mmHg through 15 mmHg for 5 hours, to obtain an intermediate polyester A-1.

Next, the intermediate polyester A-1 and a hexamethylene isocyanate derivative (HDI isocyanurate) were added into a reaction tank equipped with a heater, a condenser tube, a stirrer, and a nitrogen introducing tube in a manner that the mole ratio (NCO:OH) between the isocyanate group of the HDI isocyanurate and the hydroxyl group of the intermediate polyester A-1 would be 2.0, and ethyl acetate was added into the reaction tank to dissolve the materials in a manner to produce a 50% ethyl acetate solution. Subsequently, the resulting product was subjected to temperature elevation to 80° C. and reacted for 5 hours under a nitrogen airflow, to obtain an ethyl acetate solution of a prepolymer (terminally OH group-containing prepolymer A-1) containing a hydroxyl group at a terminal. Subsequently, the ethyl acetate solution of the terminally OH group-containing prepolymer A-1 was decompressed until the amount of residual ethyl acetate in the ethyl acetate solution became 100 ppm or less.

Next, the terminally OH group-containing prepolymer A-1 and monomethyl ester succinic acid were added into a reaction tank equipped with a heater, a condenser tube, a stirrer, and a nitrogen introducing tube in a manner that the mole ratio (CH₃:OH) between the methyl group of the monomethyl ester succinic acid and the hydroxyl group of the terminally OH group-containing prepolymer A-1 would be 2.0, and were reacted at 150° C. for 6 hours, to obtain a carboxylic acid-terminated prepolymer [Prepolymer A-1], which was a nonlinear polymer.

<Synthesis of Amorphous Polyester Resin B-1>

An adduct of bisphenol A with 2 moles of ethylene oxide, an adduct of bisphenol A with 2 moles of propylene oxide, terephthalic acid, and adipic acid were added into a four-necked flask equipped with a nitrogen introducing tube, a dewatering tube, a stirrer, and a thermocouple in a manner that the mole ratio (adduct of bisphenol A with 2 moles of propylene oxide:adduct of bisphenol A with 2 moles of ethylene oxide) between the adduct of bisphenol A with 2 moles of propylene oxide and the adduct of bisphenol A with 2 moles of ethylene oxide would be 60:40, the mole ratio (terephthalic acid:adipic acid) between terephthalic acid and adipic acid would be 97:3, and the mole ratio (OH:COOH) between hydroxyl group and carboxyl group would be 1.3. The materials were reacted in the presence of titanium tetraisopropoxide (500 ppm relative to the resin components) at normal pressure at 230° C. for 8 hours, and further reacted at a reduced pressure of from 10 mmHg through 15 mmHg for 4 hours. Subsequently, trimellitic anhydride was added into the reaction container by 1 mol % relative to all resin components, and reacted with the materials at 180° C. at normal pressure for 3 hours, to obtain [Amorphous polyester resin B-1].

<Synthesis of Amorphous Polyester Resin B-2>

Propylene glycol, an adduct of bisphenol A with 2 moles of propylene oxide, terephthalic acid, and plant-derived succinic acid were added into a four-necked flask equipped with a nitrogen introducing tube, a dewatering tube, a stirrer, and a thermocouple in a manner that the mole ratio (propylene glycol:adduct of bisphenol A with 2 moles of propylene oxide) between propylene glycol and the adduct of bisphenol A with 2 moles of propylene oxide would be 60:40, the mole ratio (terephthalic acid:succinic acid) between terephthalic acid and succinic acid would be 86:14, and the mole ratio (OH:COOH) between hydroxyl group and carboxyl group would be 1.3. The materials were reacted in the presence of titanium tetraisopropoxide (500 ppm relative to the resin components) at normal pressure at 230° C. for 8 hours, and further reacted at a reduced pressure of from 10 mmHg through 15 mmHg for 4 hours. Subsequently, trimellitic anhydride was added into the reaction container by 1 mol % relative to all resin components, and reacted with the materials at 180° C. at normal pressure for 3 hours, to obtain [Amorphous polyester resin B-2].

<Synthesis of Crystalline Polyester Resin (Cpes) C-1>

Plant-derived sebacic acid and 1,6-hexanediol were added into a 5 L four-necked flask equipped with a nitrogen introducing tube, a dewatering tube, a stirrer, and a thermocouple in a manner that the mole ratio (OH:COOH) between hydroxyl group and carboxyl group would be 0.9. The materials were reacted in the presence of titanium tetraisopropoxide (500 ppm relative to the resin components) at 180° C. for 10 hours, reacted at an elevated temperature of 200° C. for 3 hours, and further reacted at a pressure of 8.3 kPa for 2 hours, to obtain [Crystalline polyester resin C-1].

<Production of Crystalline Polyester Resin Dispersion Liquid 1>

[Crystalline polyester resin C-1] (45 parts) and ethyl acetate (450 parts) were added into a container equipped with a stirring bar and a thermometer, subjected to temperature elevation to 80° C. while being stirred, retained at 80° C. for 5 hours, then cooled to 30° C. in 1 hour, and subjected to dispersion treatment using a bead mill (ULTRA VISCOMILL, obtained from IMEX Co., Ltd.) packed with zirconia beads having a diameter of 0.5 mm to 80% by volume, at a liquid sending speed of 1 kg/hr, at a disk surface speed of 6 m/sec, for 3 passes, to obtain [Crystalline polyester resin dispersion liquid 1]. The volume mean particle diameter of the obtained crystalline polyester resin particles was 350 nm, and the concentration of the solid component formed of the resin particles in the dispersion liquid was 10%.

<Production of Wax Dispersion Liquid W-1>

An ester wax (obtained from NOF Corporation, WE-11, a synthetic wax of a plant-derived monomer, having a melting point of 67° C.) (180 parts) and an anionic surfactant (obtained from DKS Co., Ltd., NEOGEN SC, sodium dodecylbenzene sulfonate) (17 parts) serving as a surfactant were added to ion-exchanged water (720 parts).

The resulting product was subjected to dispersion treatment using a homogenizer while being heated to 90° C., to obtain [Wax dispersion liquid W-1], The volume mean particle diameter of the obtained wax particles was 250 nm, and the concentration of the solid component formed of the wax particles in the dispersion liquid was 25%.

<Preparation of Masterbatch (MB)>

Water (1,200 parts), carbon black (PRINTEX 35, obtained from Degussa AG, having a DBP oil absorption of 42 mL/100 mg and pH of 9.5) (500 parts), and [Amorphous polyester resin B-1] (500 parts) were added together, and mixed using a Henschel mixer (obtained from Nippon Coke & Engineering Co., ltd.). The mixture was kneaded using two rolls at 150° C. for 30 minutes, rolled and cooled, and then pulverized using a pulverizer, to obtain [Masterbatch MB-1].

<P-1: Introduction of PET>

Flake-shaped recycled PET was mixed during mixing of the materials in <Synthesis of amorphous polyester resin> described above in a manner that the ratio of the solid component formed of PET would be as presented in Table 1-2.

<Preparation of Oil Phase>

[Prepolymer A-1] (45 parts), [Wax dispersion liquid W-1] (200 parts including a solid component by 50 parts), [Crystalline polyester resin dispersion liquid 1] (500 parts including a solid component by 50 parts), [Amorphous polyester resin B-1] (525 parts) (+225 parts of PET), [Masterbatch MB-1] (50 parts) (pigment) were added into a container, and mixed using a TK homo-mixer (obtained from PRIMIX Corporation) at 5,000 rpm for 60 minutes, to obtain [Oil phase 1].

Each blending amount specified above represents the amount of a solid component formed of each raw material.

<Preparation of Water Phase>

Water (990 parts), sodium dodecyl sulfonate (20 parts), and ethyl acetate (90 parts) were mixed and stirred, to obtain a milky white liquid. This was used as [Water phase 1].

<Emulsification>

While [Oil phase 1] (700 parts) was stirred using a TK homo-mixer at a rotation number of 8,000 rpm, 28% ammonia water (20 parts) were added and mixed with [Oil phase 1] for 10 minutes, and then [Water phase 1] (1,200 parts) was gradually dropped into the resulting product, to obtain [Emulsified slurry 1].

<Solvent Removal>

[Emulsified slurry 1] was added into a container equipped with a stirrer and a thermometer, and subjected to solvent removal at 30° C. for 180 minutes, to obtain [Solvent-removed slurry 1].

<Flocculation>

A 3% magnesium chloride solution (100 parts) was dropped into [Solvent-removed slurry 1]. The resulting product was stirred for 5 minutes, and subjected to temperature elevation to 60° C. When the particle diameter of the resulting product became 5.0 μm, sodium chloride (50 parts) was added to terminate the flocculating step, to obtain [Flocculated slurry 1].

<Fusing>

[Flocculated slurry 1] was heated to 70° C. while being stirred. When the average circularity of [Flocculated slurry 1] became a desired value of 0.957, [Flocculated slurry 1] was cooled, to obtain [Dispersed slurry 1].

<Washing/Drying>

After [Dispersed slurry 1] (100 parts) was filtrated at reduced pressure:
(1) Ion-exchanged water (100 parts) was added to the filtration cake. The resulting product was mixed using a TK homo-mixer (at a rotation number of 12,000 rpm for 10 minutes), and then filtrated;
(2) A 10% sodium hydroxide aqueous solution (100 parts) was added to the filtration cake obtained in (1). The resulting product was mixed using a TK homo-mixer (at a rotation number of 12,000 rpm for 30 minutes), and then filtrated at a reduced pressure;
(3) A 10% hydrochloric acid (100 parts) was added to the filtration cake obtained in (2). The resulting product was mixed using a TK homo-mixer (at a rotation number of 12,000 rpm for 10 minutes), and then filtrated; and
(4) Ion-exchanged water (300 parts) was added to the filtration cake obtained in (3). The resulting product was mixed using a TK homo-mixer (at a rotation number of 12,000 rpm for 10 minutes), and then filtrated.

The operations (1) to (4) specified above were performed twice, to obtain [Filtration cake 1].

[Filtration cake 1] was dried using an air-circulating dryer at 45° C. for 48 hours, and sieved through a mesh having a mesh size of 75 μm, to obtain [Resin particle base 1].

<Treatment Step Using External Additive>

Hydrophobic silica (HDK-2000, obtained from Clariant AG) (2.0 parts) serving as an external additive was mixed with [Resin particle base 1] (100 parts) using a Henschel mixer. The resulting product was passed through a mesh sieve having a mesh size of 500, to obtain [Resin particles 1].

Resin particles 2 to 11 were produced in the same manner as the resin particles 1, except that the kind of the metal salt added in the flocculating step, and of the prepolymer, the wax dispersion liquid, the crystalline resin, the amorphous resin, and PET, and the number of parts by which they were added were changed as presented in Tables 1-1 and 1-2.

Environmental friendliness, low-temperature fixability, durability, and high-temperature fixability of these resin particles were evaluated.

The results are presented in Table 2-2.

In Table 2-1, “Present (propylene glycol)” written in the field of “Plant-derived alcohol monomer” means that petroleum-derived propylene glycol used in the synthesis of the amorphous polyester resin B-2 was replaced with corn-derived propylene glycol. In Table 2-1, “Gel content” represents the mass percentage of the THF-insoluble component, “Cpes” represents the mass percentage of the crystalline resin relative to the total of the amorphous resin and PET contained in the resin particles, and “PET” represents the mass percentage of PET contained in the resin particles.

(Evaluation Method)

<Environmental Friendliness>

Environmental friendliness was determined based on the ratio of an environmentally-friendly resin in the toner. The criteria for determination are as follows.
A: A plant-derived alcohol component was introduced into the amorphous resin, and PET accounted for 30% or more of the amorphous resin.
B: A plant-derived alcohol component was introduced into the amorphous resin, and PET accounted for less than 30% of the amorphous resin.
D: The amorphous resin was synthesized with a petroleum-derived monomer.

<Low-Temperature Fixability>

A carrier used in an IMAGIO MP C5503 (obtained from Ricoh Company, Ltd.) and the resin particles obtained above were mixed in a manner that the concentration of the resin particles would be 5% by mass, to obtain a developer.

A unit of the IMAGIO MP C5503 (obtained from Ricoh Company, Ltd.) was filled with the developer, and a rectangular solid image having a size of 2 cm×15 cm was formed on PPC paper TYPE 6000 (70W, A4-sized, grain short paper, obtained from Ricoh Company, Ltd.) in manner that the toner would be attached by an amount of 0.40 mg/cm². Here, while the surface temperature of the fixing roller was varied, the temperature at which a cold offset, in which the developed solid image would be fixed on a location other than a desired location, would occur was measured, to evaluate low-temperature fixability. B and C are passing grades.

[Evaluation criteria]
B: Lower than 110° C.
C: 110° C. or higher and lower than 125° C.
D: 125° C. or higher

<Durability>

The toner was removed from the developer by blow-off after the developer was used in copying tests on 100,000 sheets. The weight of the remaining carrier was obtained as a measurement W1. Next, the carrier was added to toluene, to dissolve and wash away any melt. Then, the carrier was dried, and the weight of the dried carrier was obtained as a measurement W2. A spending percentage was calculated according to the formula below, to evaluate durability. B and C are passing grades.

Spending percentage=[(W1−W2)/W1]×100

[Evaluation criteria]
B: 0.01 wt % or higher and lower than 0.02 wt %
C: 0.02 wt- or higher and lower than 0.05 wt %
D: 0.05 wt % or higher

<High-Temperature Fixability>

Using a fixing unit of a color multifunction peripheral (IMAGIO MP C5503, obtained from Ricoh Company, Ltd.), a black unfixed image having an amount of 0.6 mg/cm² was formed on plain paper and fixed at varying fixing temperatures. The temperature at which a hot offset would occur was measured and evaluated by four grades. A and B are passing grades.
A: 190° C. or higher
B: 180° C. or higher and lower than 190° C.
C: 170° C. or higher and lower than 180° C.
D: Lower than 170° C.

TABLE 1-1

| | Kind | | | | | | |
|---|---|---|---|---|---|---|---|
| | | Added | | | | | |
| Resin | | metal | | Crystalline | Amorphous | | |
| particles | Prepolymer | salt | Wax | resin | resin | PET | MB |
| Resin | A-1 | MgCl₂ | W-1 | C-1 | B-1 | P-1 | MB-1 |
| particles 1 | | | | | | | |
| Resin | A-1 | MgCl₂ | W-1 | C-1 | B-2 | P-1 | MB-1 |
| particles 2 | | | | | | | |
| Resin | A-1 | MgCl₂ | W-1 | C-1 | B-2 | P-1 | MB-1 |
| particles 3 | | | | | | | |
| Resin | A-1 | MgCl₂ | W-1 | C-1 | B-2 | P-1 | MB-1 |
| particles 4 | | | | | | | |
| Resin | A-1 | MgCl₂ | W-1 | C-1 | B-2 | P-1 | MB-1 |
| particles 5 | | | | | | | |
| Resin | A-1 | MgCl₂ | W-1 | C-1 | B-2 | P-1 | MB-1 |
| particles 6 | | | | | | | |
| Resin | A-1 | MgCl₂ | W-1 | C-1 | B-2 | P-1 | MB-1 |
| particles 7 | | | | | | | |
| Resin | A-1 | MgCl₂ | W-1 | C-1 | B-2 | — | MB-1 |
| particles 8 | | | | | | | |
| Resin | A-1 | MgCl₂ | W-1 | — | B-2 | — | MB-1 |
| particles 9 | | | | | | | |
| Resin | A-1 | MgCl₂ | W-1 | — | B-2 | — | MB-1 |
| particles 10 | | | | | | | |
| Resin | A-1 | MgCl₂ | W-1 | — | B-2 | — | MB-1 |
| particles 11 | | | | | | | |

TABLE 1-2

| | Number of parts added (solid component) | | | | | |
|---|---|---|---|---|---|---|
| Resin | | | Crystalline | Amorphous | | |
| particles | Prepolymer | Wax | resin | resin | PET | MB |
| Resin | 45 | 50 | 50 | 525 | 225 | 100 |
| particles 1 | | | | | | |
| Resin | 22.5 | 50 | 50 | 525 | 225 | 100 |
| particles 2 | | | | | | |
| Resin | 75 | 50 | 50 | 525 | 225 | 100 |
| particles 3 | | | | | | |
| Resin | 45 | 50 | 50 | 470 | 280 | 100 |
| particles 4 | | | | | | |
| Resin | 45 | 50 | 50 | 700 | 50 | 100 |
| particles 5 | | | | | | |
| Resin | 45 | 50 | 50 | 450 | 300 | 100 |
| particles 6 | | | | | | |
| Resin | 45 | 50 | 50 | 710 | 40 | 100 |
| particles 7 | | | | | | |
| Resin | 45 | 50 | 50 | 750 | 0 | 100 |
| particles 8 | | | | | | |
| Resin | 45 | 50 | 0 | 750 | 0 | 100 |
| particles 9 | | | | | | |
| Resin | 75 | 50 | 0 | 750 | 0 | 100 |
| particles 10 | | | | | | |
| Resin | 22.5 | 50 | 0 | 750 | 0 | 100 |
| particles 11 | | | | | | |

TABLE 2-1

| | | Plant-derived | Gel | | |
|---|---|---|---|---|---|
| | | alcohol monomer | content | Cpes | PET |
| Comp. | Resin | Absent | 20.0 | 6.0 | 30.0 |
| Ex. 1 | particles 1 | | | | |
| Comp. | Resin | Present | 4.9 | 6.0 | 30.0 |
| Ex. 2 | particles 2 | (propylene glycol) | | | |
| Comp. | Resin | Present | 40.1 | 6.0 | 30.0 |
| Ex. 3 | particles 3 | ( propylene glycol) | | | |
| Ex. 1 | Resin | Present | 20.0 | 6.0 | 38.9 |
| | particles 4 | (propylene glycol) | | | |
| Ex. 2 | Resin | Present | 20.0 | 6.0 | 6.1 |
| | particles 5 | ( propylene glycol) | | | |
| Ex. 3 | Resin | Present | 20.0 | 6.0 | 39.1 |
| | particles 6 | (propylene glycol) | | | |
| Ex. 4 | Resin | Present | 20.0 | 6.0 | 5.9 |
| | particles 7 | (propylene glycol) | | | |
| Ex. 5 | Resin | Present | 20.0 | 6.0 | 0.0 |
| | particles 8 | (propylene glycol) | | | |
| Ex. 6 | Resin | Present | 20.0 | 0.0 | 0.0 |
| | particles 9 | ( propylene glycol) | | | |
| Ex. 7 | Resin | Present | 39.9 | 0.0 | 0.0 |
| | particles 10 | ( propylene glycol) | | | |
| Ex. 8 | Resin | Present | 5.1 | 0.0 | 0.0 |
| | particles 11 | ( propylene glycol) | | | |

TABLE 2-2

| | | Quality | | | |
|---|---|---|---|---|---|
| | | | Low- | | High- |
| | | Environmental | temperature | Dur- | temperature |
| | | friendliness | fixability | ability | fixability |
| Comp. | Resin | D | B | B | B |
| Ex. 1 | particles 1 | | | | |
| Comp. | Resin | B | B | D | D |
| Ex. 2 | particles 2 | | | | |
| Comp. | Resin | B | B | B | D |
| Ex. 3 | particles 3 | | | | |
| Ex. 1 | Resin | A | B | B | B |
| | particles 4 | | | | |
| Ex. 2 | Resin | A | B | B | B |
| | particles 5 | | | | |
| Ex. 3 | Resin | A | C | B | B |
| | particles 6 | | | | |
| Ex. 4 | Resin | B | B | B | B |
| | particles 7 | | | | |
| Ex. 5 | Resin | B | B | B | B |
| | particles 8 | | | | |
| Ex. 6 | Resin | B | C | B | B |
| | particles 9 | | | | |
| Ex. 7 | Resin | B | C | B | B |
| | particles 10 | | | | |
| Ex. 8 | Resin | B | C | C | B |
| | particles 11 | | | | |

For example, embodiments of the present disclosure are as follows.

<1> Resin particles, comprising:
one or more binder resins;
a release agent; and
a colorant,
wherein the one or more binder resins comprise an amorphous resin,
the amorphous resin contains an alcohol component as one of constituents thereof, the alcohol component comprising a plant-derived alcohol component, and
the resin particles comprise a tetrahydrofuran (THF)-insoluble component by an amount of from 5% by mass through 40% by mass.

<2> The resin particles according to <1>,
wherein the alcohol component of the amorphous resin comprises plant-derived 1,2-propanediol.

<3> The resin particles according to <1> or <2>,
wherein the one or more binder resins further comprise a crystalline resin.

<4> The resin particles according to any one of <1> to <3>,
wherein the one or more binder resins further comprise polyethylene terephthalate (PET) or polybutylene terephthalate (PBT).

<5> A toner, comprising:
the resin particles of any one of <1> to <4>.

Further, the present invention is not limited to these embodiments, but various variations and modifications may be made without departing from the scope of the present invention.

What is claimed is:

1. Resin particles, comprising:
one or more binder resins;
a release agent; and
a colorant,
wherein the one or more binder resins comprise an amorphous resin,
the amorphous resin contains an alcohol component as one of constituents thereof, the alcohol component comprising a plant-derived alcohol component, and
the resin particles comprise a tetrahydrofuran (THF)-insoluble component by an amount of from 5% by mass through 40% by mass.

2. The resin particles according to claim 1,
wherein the alcohol component of the amorphous resin comprises plant-derived 1,2-propanediol.

3. The resin particles according to claim 1,
wherein the one or more binder resins further comprise a crystalline resin.

4. The resin particles according to claim 1,
wherein the one or more binder resins further comprise polyethylene terephthalate (PET) or polybutylene terephthalate (PBT).

5. A toner, comprising:
the resin particles of claim 1.
